(19) United States
(12) Patent Application Publication
(10) Pub. No.: US 2003/0183958 A1
(43) Pub. Date: Oct. 2, 2003

(54) Multi-well plate fabrication

(75) Inventors: Michael Craig Goff, Raleigh, NC (US); Scott O'Connor, Durham, NC (US); Larry Monahan, Willow Spring, NC (US); Scott White, Raleigh, NC (US); Andy Muser, Durham, NC (US); John P. Hall, Raleigh, NC (US); Frank E. Martin, Durham, NC (US)

Correspondence Address: STROOCK & STROOCK & LAVAN LLP, 180 MAIDEN LANE, NEW YORK, NY, 10038, US

(73) Assignee: Becton, Dickinson and Company

(21) Appl. No.: 10/107,826

(22) Filed: Mar. 28, 2002

(51) Int. Cl. B29D 11/00

(52) U.S. Cl. 264/1.7

(57) ABSTRACT

A method which utilizes injection-compression is provided for forming a multiwell plate having a clear lens. The method includes forming a multiwell plate body and having a clear lens injection-compressed thereto so as to be fused to the body to cover at least a portion of the wells of the body.

### 1. FIELD OF THE INVENTION

This invention relates to techniques for forming multiwell plates and, more particularly, to molding multiwell plates.

### 2. BACKGROUND OF THE INVENTION

Multiwell plates are known in the prior art for use in bioassays. It is also known from the prior art to have a clear lens at the base of the wells to allow researchers to use optically-based analytical techniques for studying materials within the wells, such as tissue cultures.

Various techniques have been developed to form multiwell plates having a clear lens. In one technique, the body of the multiwell plate (which is typically made of opaque material to minimize reflectance) is separately formed from the clear lens, with the clear lens being bonded to the body. Typically, both components are injection molded. With respect to a second technique, a multiwell plate body is initially injection molded, but not ejected from the mold. Thereafter, a thin film is placed in the mold with a clear layer of clear plastic being molded over the film to form the lens portion.

The prior art techniques, however, have several deficiencies. Generally, the process of molding on to a lens causes deformation of the lens surface. In addition, the planarity of the lenses is not consistent from well to well, thereby resulting in unequal transmission of light, and creating a focal plane which is not consistent across the well array (or within an individual well), causing difficulties in measurements requiring a constant focal length.

### 3. SUMMARY OF THE INVENTION

The subject invention provides a method which utilizes injection-compression for forming a multiwell plate having a clear lens. Particularly, a multiwell plate body is initially injection molded and left in a mold cavity. Thereafter, the mold cavity is adjusted to define a second mold cavity adjacent to an end of the multiwell plate body. A clear lens portion is formed in the second mold cavity using injection-compression, which also causes the lens to be fused to the multiwell plate body. Specifically, with injection-compression, a bolus of molten material is injected into the second mold cavity. The second mold cavity is adjusted such that its volume is reduced, resulting in compression of the molten material. The combined effect of the reduction of volume of the second mold cavity, and the compressive forces acting on the molten material, results in a complete filling of the reduced-volume second mold cavity and formation of a clear lens which is fused to the multiwell plate body.

The multiwell plate can be formed of different materials: for example, a colored polymer for the multiwell plate body, and a clear polymer from the same polymer family for the clear lens. Alternatively, the same material, but of different colors can be used, such as a colored polystyrene to form the multiwell plate body, and a clear polystyrene to form the lens. In selecting materials, proper adhesion of the clear lens and the multiwell plate body must be considered.

It is has been found that the technique allows for a clear lens to be more consistently formed than in the prior art, resulting in less loss of light in optical recording and improved imaging. Also, lower levels of molded-in stress in the clear lens are found than with prior art techniques resulting in better optical properties. Furthermore, the physical properties (e.g., flexural modulus) of the clear lens may be improved and higher material densification may be achieved with injection-compression.

These and other features of the invention will be better understood through a study of the following detailed description and accompanying drawings.

### 4. BRIEF DESCRIPTION OF THE DRAWINGS

FIG. 1 is a perspective view of a multiwell plate;

FIG. 2 is a partial cross-sectional elevational view of a multiwell plate;

FIG. 3 is a schematic representing formation of a multiwell plate body in a first mold cavity;

FIG. 4 is a schematic representing adjustment of the mold elements to define a second mold cavity;

FIG. 5 is a schematic showing a bolus of molten material disposed in the second mold cavity; and,

FIG. 6 is a schematic representing the multiwell plate in the mold cavities.

### 5. DETAILED DESCRIPTION OF THE INVENTION

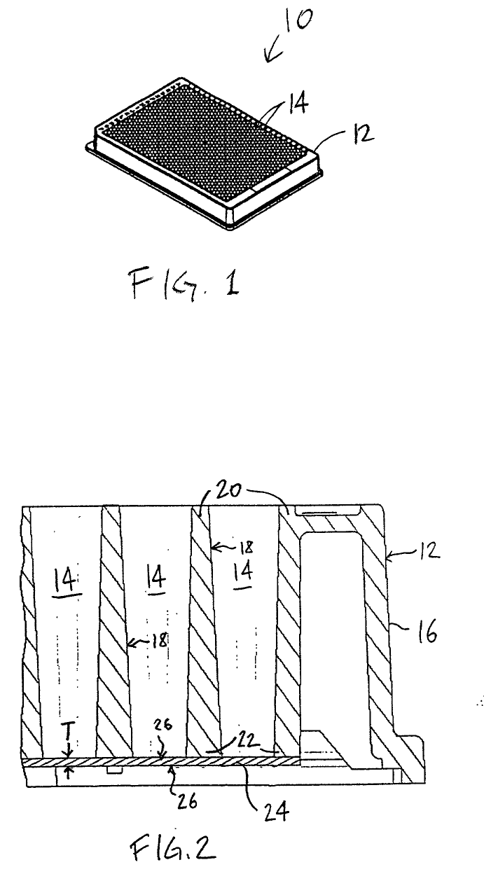

With reference to FIG. 1, a typical multiwell plate 10 is shown therein having a multiwell plate body 12 with an array of wells 14 formed therethrough. The use of multiwell plates in bioassays is well known in the prior art, and the multiwell plate 10 is formed to be compatible, both structurally and dimensionally, with such bioassay techniques. In addition, certain arrays of the wells 14 have been accepted in the prior art, including an array of 96 wells, 384 wells (as shown in FIG. 1), and 1,536 wells. Beyond the conventional numbers of wells, any number may be used in any array configuration.

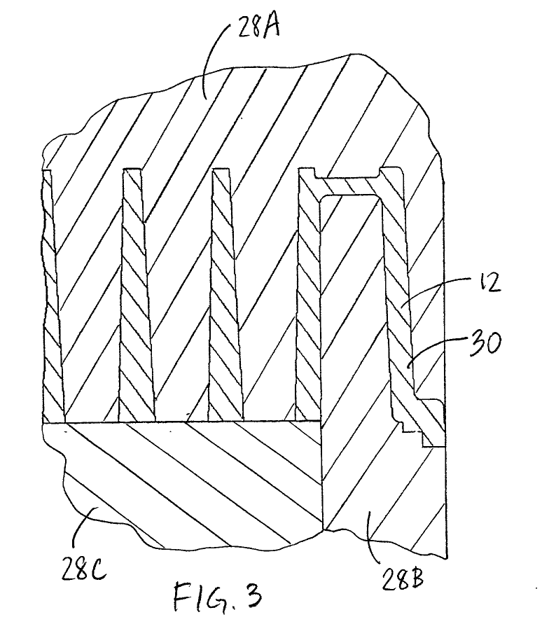

Referring to FIG. 2, the multiwell plate body 12 is preferably unitarily formed of a thermoplastic material, and includes a sidewall 16 and a network of inner walls 18 which define the wells 14. The walls 18 are preferably tapered so as to diverge from upper ends 20 of the walls 18 to lower ends 22 of the walls. As a result, the wells 14 are each downwardly convergent.

A clear lens 24 is fixed to the lower portions 22 of the walls 18 so as to at least partially cover the wells 14 and to seal the bottoms thereof. Preferably, the lens 24 covers and seals all of the wells 14 so that no intermixing between the wells 14 may occur. The clear lens 24 is generally planar, having flat opposing surfaces 26 which are generally parallel. As shown in FIG. 2, it is preferred that all portions of the clear lens 24 be below the walls 18, with no portion extending into any of the wells 14. Also, it is preferred that the thickness T of the clear lens 24 be in the range of 0.004 inches-0.015 inches. With this relatively low range of thicknesses, and with good planarity of the clear lens 24, highly-acceptable optical characteristics with the subject invention can be achieved.

With the subject invention, the clear lens 24 is fused to the multiwell plate body 12 using injection-compression. Accordingly, the materials of the multiwell plate body 12 and the clear lens 24 must have acceptable adhesion characteristics. The same material may be used for both components, such as colored polystyrene to form the multiwell plate body 12, and clear polystyrene to form the clear lens 24. It is preferred that the multiwell plate body 12 be formed opaque to control light conditions in any optical testing.

With reference to FIGS. 3-6, a method for forming the multiwell plate is shown therein. In a first step, mold elements 28A, 28B, 28C are arranged to define a first mold cavity 30 for forming the multiwell plate body 12. Although three of the mold elements 28A-28C are being referred to herein, and shown in the figures, as recognized by those skilled in the art, any number of the mold elements may be used consistent with the principles described herein. The multiwell plate body 12 is formed in the first mold cavity 30 using known techniques, preferably injection molding.

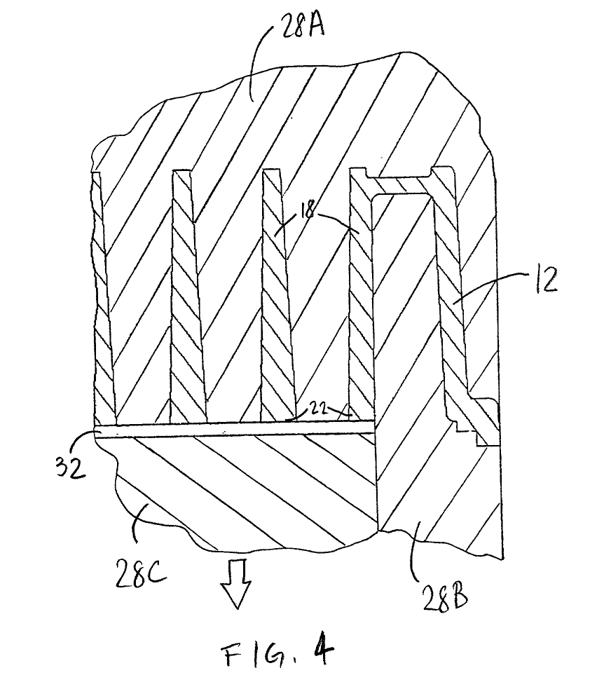

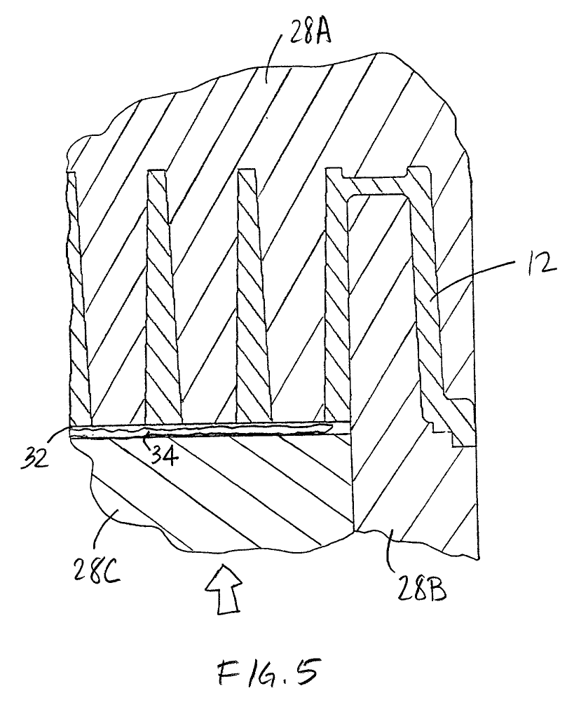

FIGS. 4-6 depict the injection-compression technique of the subject invention. With reference to FIG. 4, once the multiwell plate body 12 is formed, the mold elements 28A-28C are adjusted so as to define a second mold cavity 32 adjacent to the lower portions 22 of the walls 18. For example, with the mold elements 28A and 28B being stationary, the mold element 28C is retracted as shown by the arrow in FIG. 4. The volume of the second mold cavity 32 is to be greater than the volume of the clear lens 24.

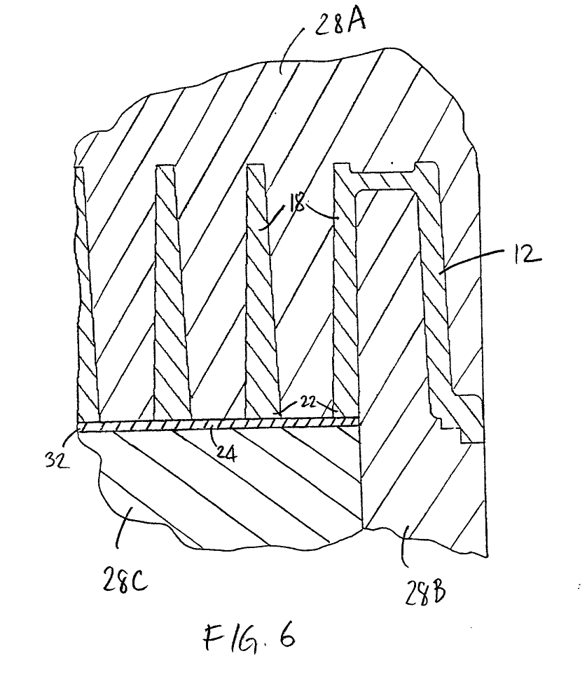

Thereafter, as shown in FIG. 5, a bolus of molten material 34 is injected into the second mold cavity 32. To assist in proper injection of the bolus 34, vacuum may be applied to the second mold cavity 32 prior to and/or during the injection. The bolus 34 constitutes the constituent material which is to form the clear lens 24. After, and/or during, injection of the bolus 34, the mold elements 28A-28C are adjusted so as to reduce the volume of the second mold cavity 32 and cause compression of the bolus 34. For example, the mold element 28C may be moved forwardly as shown by the arrow in FIG. 5. As shown in FIG. 6, the reduction of volume of the second mold cavity 32, along with the compressive force applied to the bolus 34, results in the bolus 34 filling out the reduced-volume second mold cavity 32 to define the clear lens 24. Simultaneously, the clear lens 24 is fused to the lower portions 22 of the walls 18. Once sufficiently cooled, the assembly may be ejected from the mold elements 28A-28C.

As described above, it is preferred that the multiwell plate body 12 not be ejected from the mold elements 28A-28C prior to injection-compression of the clear lens 24. Advantageously, the multiwell plate body 12 and the clear lens 24 may be formed in the same molding machine. Alternatively, the two components can be formed in separate machines, with a formed multiwell plate body 12 being placed into an apparatus suitable for injection-compression of the clear lens 24.

Because of the injection-compression technique, lower levels of molded-in stress in the clear lens 24 are developed than with prior art techniques, resulting in better optical properties. Furthermore, the physical properties (e.g., flexural modulus) of the clear lens 24 may be improved and higher material densification may be achieved with injection-compression.

Various changes and modifications can be made in the present invention. It is intended that all such changes and modifications come within the scope of the invention as set forth in the following claims.

What is claimed is:

1. A method of forming a multiwell plate, said method comprising:
forming a multiwell plate body, said multiwell plate body including an array of wells extending therethrough; and
injection-compressing a clear lens to said multiwell plate body so as to be fused to said multiwell plate body, said clear lens covering at least a portion of said wells.

2. A method as in claim 1, wherein said forming is performed in a first mold cavity of a machine and said injection-compressing is performed in a second mold cavity of said machine.

3. A method as in claim 2, wherein said multiwell plate body is not ejected from said first mold cavity prior to said injection-compressing.

4. A method as in claim 1, wherein said multiwell plate body includes a polymeric material.

5. A method as in claim 4, wherein said multiwell plate body includes a polystyrene.

6. A method as in claim 1, wherein said clear lens includes a polystyrene.

7. A method as in claim 1, wherein said clear lens includes a polyolefin.

8. A method as in claim 1, wherein said multiwell plate body includes a polyolefin.

9. A method as in claim 1, wherein said forming includes molding said multiwell plate body.

10. A method as in claim 1, wherein said multiwell plate body is opaque.

11. A method of forming a multiwell plate, said method comprising:
arranging a plurality of mold elements to define a first mold cavity;
forming a multiwell plate body in said first mold cavity, said multiwell plate body including an array of wells extending therethrough;
adjusting at least one of said mold elements to define a second mold cavity adjacent said multiwell plate body;
injecting a bolus of molten material into said second mold cavity; and,
adjusting at least one of said mold elements to reduce the volume of said second mold cavity and to compress said bolus of molten material, whereby a lens is defined that is fused to said multiwell plate body and formed to cover at least a portion of said wells.

12. A method as in claim 11, wherein said lens is clear.

13. A method as in claim 11, wherein said multiwell plate body is opaque.

14. A method as in claim 11, wherein said multiwell plate body includes a polymeric material.

15. A method as in claim 14, wherein said multiwell plate body includes a polystyrene.

16. A method as in claim 11, wherein said clear lens includes a polystyrene.

17. A method as in claim 11, wherein said clear lens includes a polyolefin.

18. A method as in claim 11, wherein said multiwell plate body includes a polyolefin.

19. A method as in claim 11, wherein said forming includes molding said multiwell plate body.

20. A method as in claim 11 further comprising applying a vacuum to said second mold cavity.
